(19) United States
(12) Patent Application Publication
(10) Pub. No.: US 2021/0133862 A1
(43) Pub. Date: May 6, 2021

(54) REAL-TIME SIGNALS ON BUYER DEMAND TO DRIVE ASPECT ADOPTION BY SELLERS

(71) Applicant: eBay Inc., San Jose, CA (US)

(72) Inventors: Vikas Singh, San Jose, CA (US); Sachin Joshi, San Jose, CA (US)

(21) Appl. No.: 16/675,897

(22) Filed: Nov. 6, 2019

(51) Int. Cl. G06Q 30/06; G06F 3/0482

(52) U.S. Cl. CPC G06Q 30/0643; H04L 67/42; G06Q 30/0605; G06F 3/0482

(57) ABSTRACT

Methods and systems for causing presentation, on a client device, of an improved user interface for managing listings of items on a network-based publication system are disclosed. It is determined whether an importance of specifying a value of an attribute for an item has transgressed an importance threshold with respect to a probability of a transaction being completed with respect to a listing of the item. It is identified that the value for the attribute has not been specified with respect to the listing of the item. It is communicated, in the user interface, the importance of specifying the value in conjunction with providing, in the user interface, an interactive user interface element for specifying the value with respect to the listing.

### TECHNICAL FIELD

The present application relates generally to the technical field of user interfaces, and, in one specific example, to user interfaces for improving completeness of listings of items posted on one or more network-based publication systems.

### BACKGROUND

A network-based publication system, such as eBay, Amazon.com, or Craigslist, may feature listings of items (e.g., goods or services). The listings may be posted by a member of the network-based publication system (e.g., a seller) and surfaced via one or more user interfaces to other members or users of the network-based publication system (e.g., potential buyers). User interfaces for such systems have some deficits relating to efficient functioning of computers. For example, users who are in the process of posting a listing of an item may not have easy access to information that would be helpful in improving or completing their listings, which may require them to, for example, access one or more separate systems to access desired data or functionality.

### BRIEF DESCRIPTION OF THE DRAWINGS

Some embodiments are illustrated by way of example and not limitation in the figures of the accompanying drawings.

FIG. 1 is a network diagram depicting a client-server system within which various example embodiments may be deployed.

FIG. 2 is a block diagram illustrating multiple server applications that, in various example embodiments, are provided as part of the networked system of FIG. 1.

FIG. 3 is a block diagram illustrating example modules of the enhanced listing application(s) of FIG. 2.

FIG. 4 is a flowchart illustrating example operations of a method of enhancing a user interface pertaining to a listing of an item.

FIG. 5 is a flowchart illustrating example operations of another method of enhancing a user interface pertaining to a listing of an item.

FIG. 6 is a flowchart illustrating example operations of a method of enhancing a user interface for managing listings of items.

FIG. 7 is a flowchart illustrating example operations of a method of enhancing user interfaces pertaining to managing listings of items with trends in demands pertaining to attributes or values of attributes of the items.

FIG. 8 is a diagram depicting an example user interface that includes enhancements pertaining to incentivizing a user to include more details about an item in a listing for the item.

FIG. 9 is a diagram depicting an example user interface that includes enhancements for specifying values of attributes of an item.

FIG. 10 is a diagram depicting an example user interface that includes enhancements for specifying values of attributes of an item.

FIG. 11 is a diagram depicting an example user interface that includes enhancements for specifying values of additional attributes of an item.

FIG. 12 is a block diagram of machine in the example form of a computer system within which instructions for causing the machine to perform any one or more of the methodologies discussed herein may be executed.

### DETAILED DESCRIPTION

In the following description, for purposes of explanation, numerous specific details are set forth in order to provide an understanding of various embodiments of the present subject matter. It will be evident, however, to those skilled in the art that various embodiments may be practiced without these specific details.

Methods for causing presentation on a client device of an improved user interface for managing listings of items on a network-based publication system are disclosed. It is determined whether an importance of specifying a value of an attribute for an item has transgressed an importance threshold with respect to a probability of a transaction being completed with respect to a listing of the item. It is identified that the value for the attribute has not been specified with respect to the listing of the item. It is communicated, in the user interface, the importance of the specifying of the value in conjunction with providing, in the user interface, an interactive user interface element for specifying the value with respect to the listing.

The methods and various operations disclosed herein may be implemented as a computer system having one or more modules (e.g., hardware modules or software modules) that are specially designed and incorporated into the computer system to perform this method or one or more of the operations described herein. These methods and various operations disclosed herein may be embodied as instructions stored on a machine-readable medium that, when executed by a machine, cause the machine to perform the method or one or more of the various operations.

The methods and various operations disclosed herein provide specific improvements over prior art systems, including, for example, improving the efficiency of using one or more electronic devices by bringing together a limited list of common functions and commonly access stored data, which, in various embodiments, can be accessed directly from within a listing posting flow of a user interface of one or more listing-creation, listing management, or post-listing management applications of a network-based publication system. The user may be able to view various data pertaining to demand of potential buyers with respect to aspects and values of those aspects with respect to listings posted on the network-based publication system (e.g., without having to navigate separately to different domains or systems to discover the pertinent information). Thus, the user's time is saved, including with respect to one or more electronic devices with small screens.

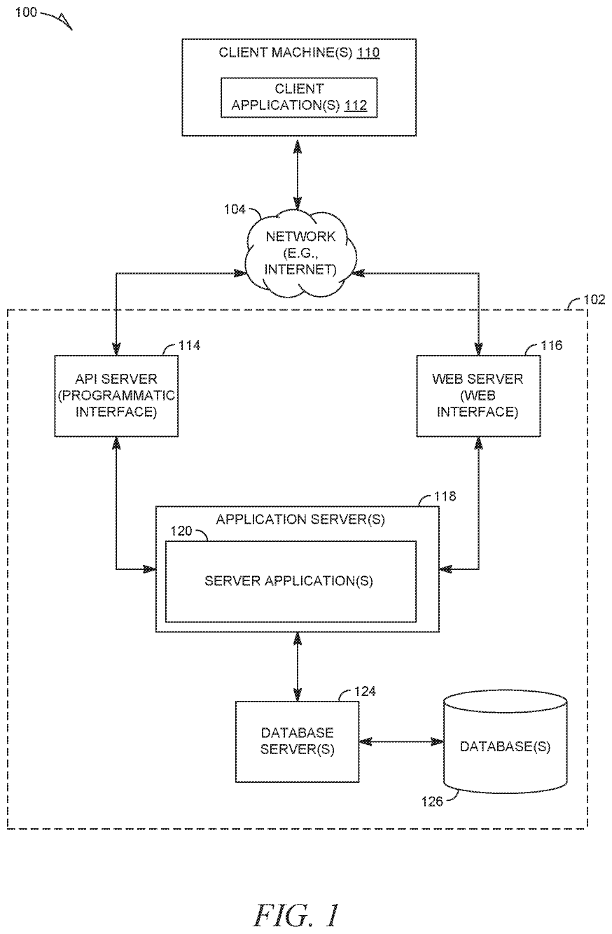

FIG. 1 is a network diagram depicting a system 100 within which various example embodiments may be deployed. A networked system 102, in the example forms of a network-based marketplace or other publication system, provides server-side functionality, via a network 104 (e.g., the Internet or Wide Area Network (WAN)) to one or more clients machines 110. FIG. 1 illustrates client application(s) 112 on the client machines 110. Examples of client application(s) 112 may include a web browser application, such as the Internet Explorer browser developed by Microsoft Corporation of Redmond, Wash. or other application supported by an operating system of the device, such as Windows, iOS or Android operating systems. Each of the client application(s) 112 may include a software application module (e.g., a plug-in, add-in, or macro) that adds a specific service or feature to a larger system.

An API server 114 and a web server 116 are coupled to, and provide programmatic and web interfaces respectively to, one or more application servers 118. The application servers 118 host one or more server application(s) 120. The application servers 118 are, in turn, shown to be coupled to one or more database servers 124 that facilitate access to one or more databases 126 or data stores, such as NoSQL or non-relational data stores.

The server applications 120 may provide a number of marketplace functions and services to users that access the networked system 102. While the server applications 120 are shown in FIG. 1 to form part of the networked system 102, in alternative embodiments, the various server applications 120 may form part of a service that is separate and distinct from the networked system 102.

Further, while the system 100 shown in FIG. 1 employs a client-server architecture, various embodiments are, of course, not limited to such an architecture, and could equally well find application in a distributed, or peer-to-peer, architecture system, for example. The various server applications 120 could also be implemented as standalone software programs, which do not necessarily have networking capabilities. Additionally, although FIG. 1 depicts client machines 110 as being coupled to a single networked system 102, it will be readily apparent to one skilled in the art that client machines 110, as well as client applications 112, may be coupled to multiple networked systems, such as payment applications associated with multiple payment processors or acquiring banks (e.g., PayPal, Visa, MasterCard, and American Express).

Web applications executing on the client machine(s) 110 may access the various server applications 120 via the web interface supported by the web server 116. Similarly, native applications executing on the client machine(s) 110 may accesses the various services and functions provided by the server applications 120 via the programmatic interface provided by the API server 114. An example of one of the client application(s) 112 may be a seller application (e.g., the TurboLister application developed by eBay Inc., of San Jose, Calif.) that enables sellers to author and manage listings on the networked system 102 in an off-line manner, and to perform batch-mode communications between the client application(s) 112 and the networked system 102. Other examples of client application(s) 112 may be third-party applications. For example, the third-party applications may, utilizing information retrieved from the networked system 102, support one or more features or functions on a website hosted by the third party. The third-party website may, for example, provide one or more promotional, marketplace or payment functions that are supported by the relevant applications of the networked system 102.

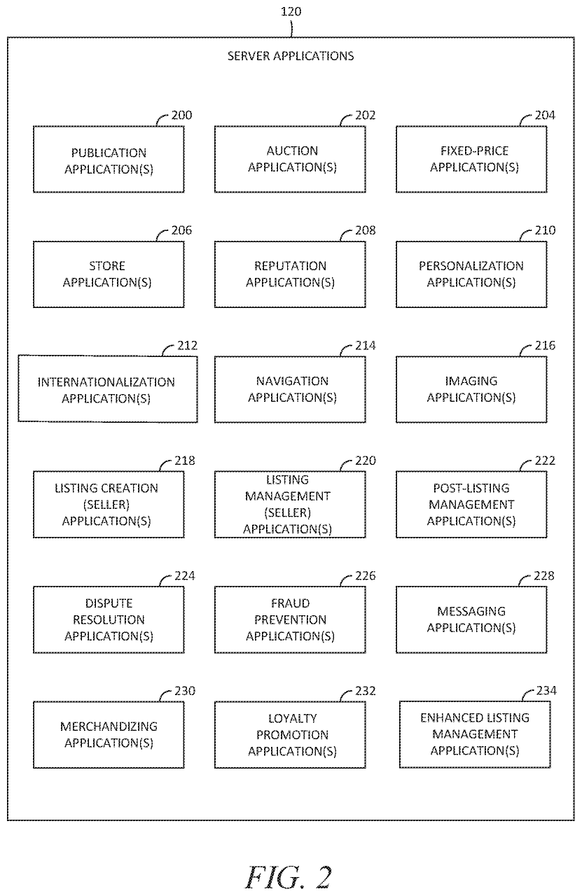

FIG. 2 is a block diagram illustrating multiple server applications 120 that, in various example embodiments, are provided as part of the networked system 102. The server applications 120 may be hosted on dedicated or shared server machines (not shown) that are communicatively coupled to enable communications between server machines. The server applications 120 themselves are communicatively coupled (e.g., via appropriate interfaces) to each other and to various data sources, so as to allow information to be passed between the server applications 120 so as to allow the server applications 120 to share and access common data. The server applications 120 may furthermore access one or more databases 126 via the database servers 124.

The networked system 102 may provide a number of publishing, listing and price-setting mechanisms whereby a seller may list (or publish information concerning) goods or services for sale, a buyer can express interest in or indicate a desire to purchase such goods or services, and a price can be set for a transaction pertaining to the goods or services. To this end, the server applications 120 are shown to include at least one publication application 200 and one or more auction applications 202 which support auction-format listing and price setting mechanisms (e.g., English, Dutch, Vickrey, Chinese, Double, Reverse auctions). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives and features that are specific and personalized to a relevant seller.

Reputation applications 208 allow users that transact, utilizing the networked system 102, to establish, build, and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user (e.g., through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. For instance, a version of the networked system 102 may be customized for the United Kingdom, whereas another version of the networked system 102 may be customized for the United States. Each of these versions may operate as an independent marketplace, or may be customized (or internationalized) presentations of a common underlying marketplace. The networked system 102 may, accordingly, include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application) may enable keyword searches of listings published via the networked system 102. A browse application may allow users to browse various category, catalogue, or inventory data structures according to which listings may be classified within the networked system 102. Various other navigation applications may be provided to supplement the search and browsing applications.

In order to make listings available via the networked system 102 as visually informing and attractive as possible, the server applications 120 may include one or more imaging applications 216, which users may utilize to upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular or predetermined seller has authored and/or published a large number of listings, the management of such listings may present a challenge. The listing management applications 220 provide a number of features (e.g., auto-relisting, inventory level monitors) to assist the seller in managing such listings. The listing creation application 218 and listing management applications 220 may allow sellers to manage listing in bulk (e.g., in a single operation, such as by an uploading of a file) and provide templates for sellers to manage category-specific, vendor-specific, or general-type-specific (e.g., catalog or ticket) listings. One or more post-listing management applications 222 also assist sellers with a number of activities that typically occur post-listing. For example, upon completion of an auction facilitated by one or more auction applications 202, a seller may wish to leave feedback regarding a particular or predetermined buyer. To this end, a post-listing management application 222 may provide an interface to one or more reputation applications 208, so as to allow the seller to conveniently provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of operations in an attempt to settle a dispute. In the event that the dispute cannot be settled via the guided procedures, the dispute may be escalated to a third-party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102. These messages may, for example, advise users regarding the status of listings at the networked system 102 (e.g., providing “outbid” notices to bidders during an auction process or providing promotional and merchandising information to users). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotion applications 232. For example, a buyer may earn loyalty or promotions points for each transaction established and/or concluded with a particular or predetermined seller, and may be offered a reward for which accumulated loyalty points can be redeemed.

Enhanced listing management application(s) 234 may include one or more applications for enhancing a listing user interface (e.g., for one or more of the listing creation applications 218, listing management applications 220, or post-listing management applications 222) with one or more user elements for facilitating providing additional details (e.g., values of aspects or attributes) pertaining to a listing.

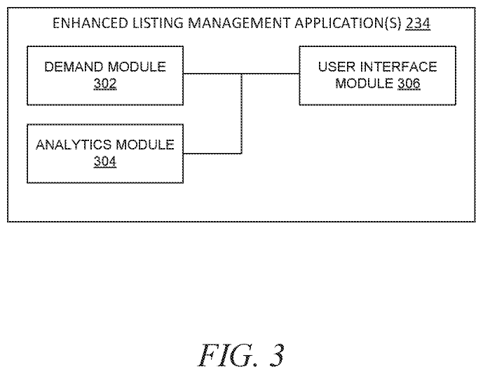

FIG. 3 is a block diagram illustrating example modules of the enhanced listing management application(s) 234. A demand module 302 is configured to determine demand data associated with one or more attributes of one or more items featured in one or more listings on the network-based publication system, as described herein. An analytics module 304 is configured to determine an impact of specifying or not specifying particular values of attributes of a listing (e.g., with respect to various metrics of interest to sellers, such as a probability of selling an item within a particular time frame). A user interface module 306 is configured to enhance one more user interfaces associated with managing listings on a network-based publication system with information pertaining to the demand data and the analytics and to provide interactive user interface elements to incentivize a seller to provide more complete details for a listing of an item.

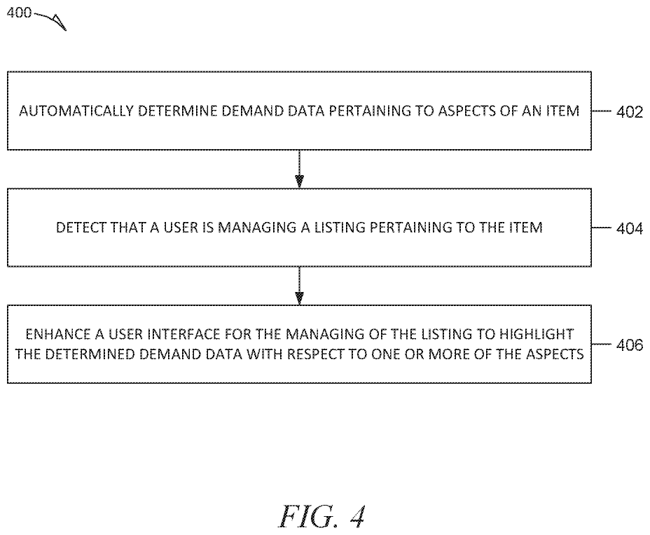

FIG. 4 is a flowchart illustrating example operations of a method 400 of enhancing a user interface pertaining to a listing of an item. In example embodiments, the operations may be performed by one or more modules of the enhanced listing management application(s) 234.

At operation 402, demand data pertaining to aspects of an item are determined (e.g., by the demand module 302). In example embodiments, historical searching behaviors of users of the network-based publication system are analyzed (e.g., over a predetermined or configurable window of time) to determine which aspects of an item the users are most interested in. For example, keywords specified in search terms are analyzed and behavior of users with respect to listings is analyzed. In example embodiments, probabilities of a listing of the item resulting in a completed transaction are analyzed using transaction records corresponding to historical listings of the same item (or items having a specified level of similarity to the item) to determine an impact of specifications of particular values of attributes on the probabilities. In addition to the probability of success of a listing, the time to sale of the listing may also be considered to determine the impact of specifying particular values of particular attributes on the time to sale. Other factors relevant to a seller in measuring the success of their listing may also be considered, such as specific factors specified by the sellers pertaining to sale prices, time to sell, and so on.

In example embodiments, it is determined that users of the network-based publication system are currently or recently (e.g., within a predetermined or configurable time window, such as from a few seconds, minutes, or hours ago up until the present moment), searching for particular aspects of the item more often (in a statistically-significant measured amount) than they have in the past (e.g., based on an analysis of historical demand data from a previous window of time). In example embodiments, particular attributes or values of attributes may be identified as trending attributes with respect to users of the network-based publication system (e.g., based on their measured degree of interest transgressing an interest threshold).

At operation 404, it is detected that a user is managing a listing pertaining to the item. For example, it is detected that a user is posting or editing a listing for the item.

At operation 406, a user interface for managing the listing is enhanced (e.g., by the user interface module 306), to include information pertaining to the demand data. For example, demand data pertaining to one or more attributes of an item for which the user has not specified a value may be highlighted within the user interface. In example embodiments, the information includes an importance of specifying a value of the attribute of the item (e.g., with respect to the various factors discussed above pertaining to completing a successful transaction pertaining to the item). In example embodiments, the user interface includes interactive user interface elements for specifying values of attributes in conjunction with the demand data to incentive the user to specify the values.

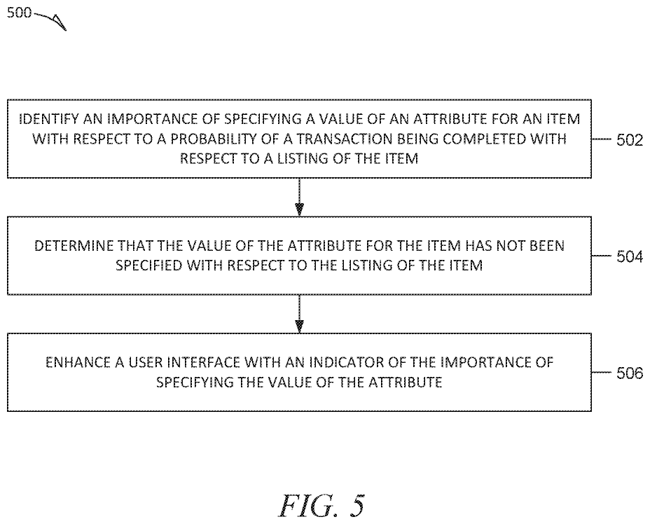

FIG. 5 is a flowchart illustrating example operations of a method 500 of enhancing a user interface pertaining to a listing of an item. In example embodiments, the operations may be performed by one or more modules of the enhanced listing management application(s) 234.

At operation 502, an importance of specifying a value of an attribute for an item is identified (e.g., with respect to a probability of a transaction being completed with respect to a listing of the item) (e.g., by the analytics module 304). For example, the analytics module 304 may determine (e.g., based on historical transaction data) that specifying a color of an item may increase the probability of a transaction for the item being completed by 50%. More specifically, the analytics module 304 may determine that particular colors being specified increase the probability by different amounts (e.g., red by 50%, blue by 65%, and orange by 45%).

At operation 504, the analytics module 304 determines that a value of the attribute for the item has not been specified with respect to the listing of the item. For example, the analytics module accesses one or more database entries associated with the listing for the item to determine whether the value for the attribute of the item has been specified

At operation 506, a user interface is enhanced (e.g., by the user interface module 306), with an indicator of the importance of specifying the value of the attribute. For example, based on a user accessing a user interface to manage a listing of the item (e.g., to create or edit the listing), the user interface may be enhanced with one or more visual indicators pertaining to the demand data or dynamic user interface elements to incentivize the user to specify the value of the attribute.

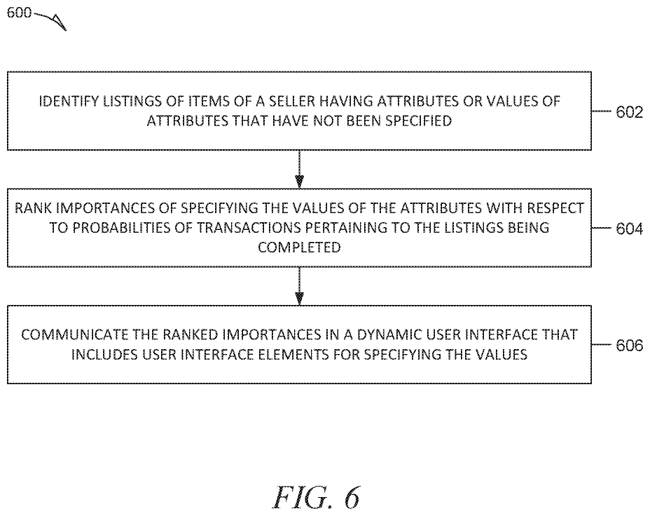

FIG. 6 is a flowchart illustrating example operations of a method 600 of enhancing a user interface for managing listings of items. In example embodiments, the operations may be performed by one or more modules of the enhanced listing management application(s) 234.

At operation 602, listings of items of a seller are identified that have attributes or values of attributes that have not been specified (e.g., by the analytics module 304).

At operation 604, importances of specifying the values of the attributes are ranked (e.g., with respect to probabilities of transactions pertaining to the listings being completed) (e.g., by the analytics module 304).

At operation 606, the ranked importances are communicated (e.g., via the user interface module 306), to the seller via a dynamic user interface that includes one or more user interface elements for specifying the values (e.g., in conjunction with information pertaining to demand data related to the values). In example embodiments, the user interface is presented during a listing flow for the item, the listing flow being a series of steps in which a seller initiates a publishing of the listing of the item on the network-based publication system.

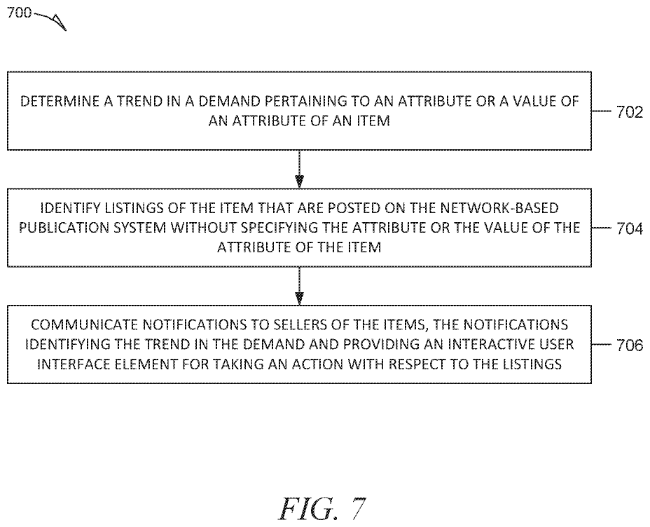

FIG. 7 is a flowchart illustrating example operations of a method 700 of enhancing user interfaces pertaining to managing listings of items with trends in demands pertaining to attributes or values of attributes of the items. In example embodiments, the operations may be performed by one or more modules of the enhanced listing management application(s) 234.

At operation 702, a trend in a demand pertaining to an attribute or value of an attribute of an item is identified. For example, user behavior data and transaction data in a recent predetermined or configurable time window are compared against historical data (e.g., from a previous configurable time window) to identify statistically-significant differences. Based on a difference being identified that transgresses a difference threshold, one or more attributes or values of attributes of an item (or a category of items) may be identified as trending attributes or values.

At operation 704, listings of items that are posted on the network-based publication without specifying the trending attribute or value of the attribute are identified.

At operation 706, notifications are communicated to sellers of the identified items. The notifications may identify the one or more attributes or values of the attributes. The notifications may further identify the listings of the items or similar items by the seller for which the seller has not specified the one or more attributes or values of the attributers. The notifications may further include interactive user interface elements for specifying one or more values for the one or more attributes for one or more listings of the item or similar items. In example embodiments, the notifications may include information pertaining to the demand data, including the trend data for the one or more attributes or the one or more values of the attributes to incentive the user to provide more complete data for their listings. In example embodiments, the notifications are included as an enhancement to a user interface pertaining to managing listings of items, as described herein.

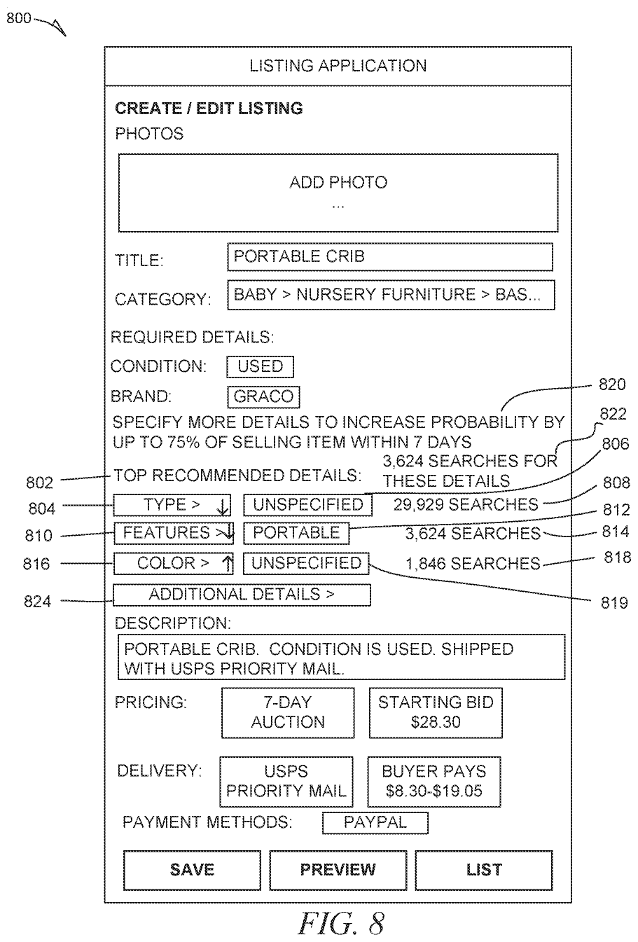

FIG. 8 is a diagram depicting an example user interface 800 that includes enhancements pertaining to incentivizing a user to include more details (e.g., values of attributes) about an item in a listing for the item. In example embodiments, the user interface 800 may be generated and communicated to a client device for presenting on the client device by one or more modules of the enhanced listing management application(s) 234.

As depicted, the user interface 800 includes information pertaining to demand data and/or transaction data that has been identified with respect to the listing of the item. For example, based on a combination of historical demand data and transaction data pertaining to the item (or similar items) featured in the listing being managed via the user interface (or a configurable range of categories of items corresponding to the item), it may be determined that specifying more details increases a probability of a successful transaction (e.g., a sale) being completed with respect to the item within a particular time frame (e.g., seven days). In example embodiments, this information is presented and dynamically updated within a user interface element 820 as more details are provided. For example, if the user provides one of the previously unspecified values for an attribute of an item, the user interface element 820 may be updated to reflect new probabilities or time-to-sale data for the listing. Additionally, demand data pertaining to recent behavior of users may be surfaced in the user interface, such as a number of searches that have been conducted by users for particular attributes of the item or values of attributes of the item (or similar items) (e.g., as depicted in user interface elements 808, 814, and 818). In example embodiments, a summary of such demand data pertaining to attributes for the item that have been specified may be provided in a user interface element (e.g., see user interface element 822), and dynamically updated as the user provides more or less of the details for the item featured in the listing.

In example embodiments, top recommended details (e.g., a configurable top number of recommended details, such as the top three details) are identified in a portion of the user interface (see, e.g., user interface element 802) that is separate from additional details (see, e.g., user interface element 824).

In example embodiments, each of the details is associated with an interactive user interface element for accessing possible values that may be specified for the corresponding attribute. (see, e.g., the user interface elements 804, 810, and 816, which are activatable to access possible values for each attribute). In example embodiments, trend data pertaining to the attributes may be surfaced in conjunction with the user interface elements to show whether and how the importances of specifying the values of the attributes have recently changed (e.g., represented as up or down trend arrows).

In example embodiments, values of attributes that have not been specified are highlighted within the user interface (e.g., see user interface elements 806 and 819.

In example embodiments, the user interface is presented during a listing flow for the item, the listing flow being a series of steps in which a seller initiates a publishing of the listing of the item on the network-based publication system.

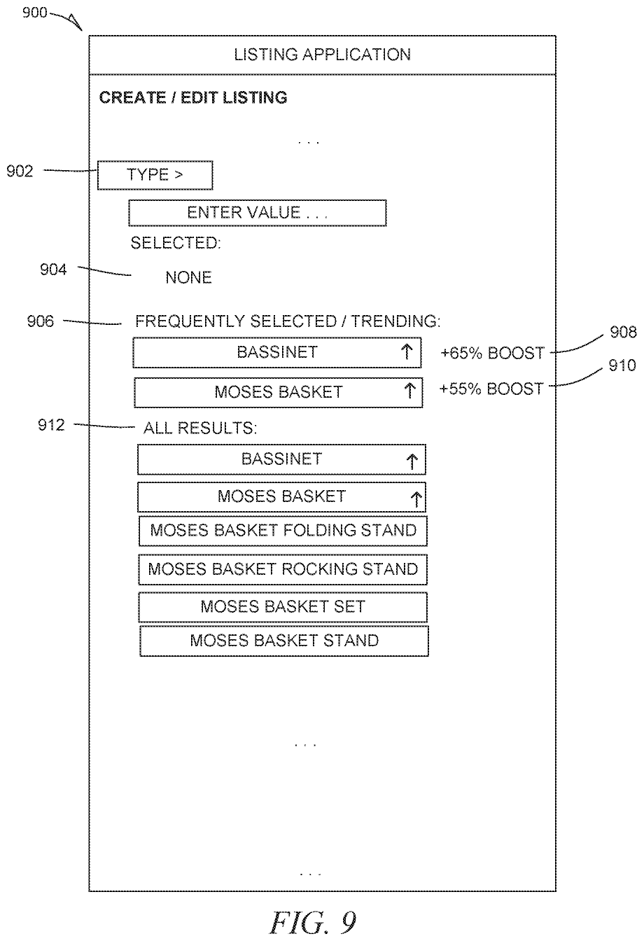

FIG. 9 is a diagram depicting an example user interface 900 that includes enhancements for specifying values of attributes of an item. In example embodiments, the user interface 900 may be generated and communicated to a client device for presentation on the client device by one or more modules of the enhanced listing management application(s) 234.

As depicted, a type attribute 902 of an item featured in a listing has been expanded in a user interface for managing the listing. Currently, no value has been specified for the attribute (e.g. see user interface element 904). In example embodiments, a portion of the expended user interface is reserved for frequently selected or trending values (e.g., see user interface element 906). In addition to an indication of the trending direction (e.g., an up or down arrow), each value may be supplemented with data pertaining to an amount of a boost the listing will get if the value is specified for the listing (e.g., see user interface elements 908 and 910). For example, as described herein, a combination of historical transaction data and demand data may be analyzed to determine the amount of the boost based on previous listings of the item or similar items. Here, the percentages may represent an increase in the likelihood that a successful transaction will be completed with respect to the listing if the respective values for the attribute of the item are specified. In example embodiments, known or previously-specified values may be included in an additional portion of the user interface (e.g., see user interface element 912). In example embodiments, the user interface may include a field for specifying a new value if an appropriate value for the attribute for the item is not found.

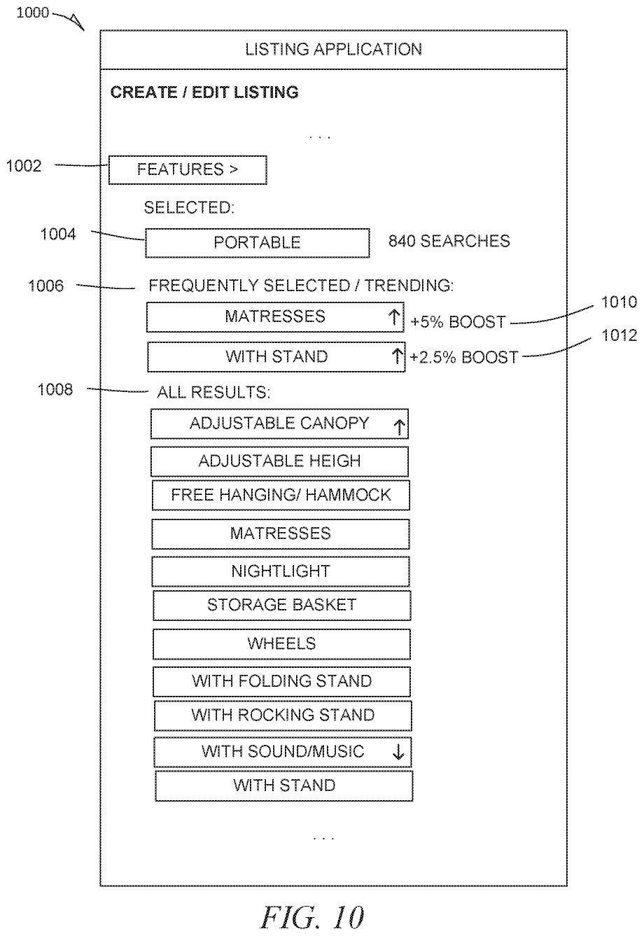

FIG. 10 is a diagram depicting an example user interface 1000 that includes enhancements for specifying values of attributes of an item. In example embodiments, the user interface 1000 may be generated and communicated to a client device for presenting on the client device by one or more modules of the enhanced listing management application(s) 234.

As depicted, the features attribute of an item featured in a listing has been expanded in a user interface for managing the listing. Currently, one value has been specified for the attribute (e.g. see user interface element 1004). In example embodiments, a portion of the expended user interface is reserved for frequently selected or trending values (e.g., see user interface element 1006) that may be specified instead of, or in addition to, the selected element. In addition to an indication of the trending direction (e.g., an up or down arrow), each value may be supplemented with data pertaining to an amount of boost the listing will get if the value is specified for the listing (e.g., see user interface elements 1010 and 1012). Here, the percentages may represent an increase in the likelihood that a successful transaction will be completed with respect to the listing if the respective values for the attribute of the item are specified. In example embodiments, known or previously-specified values may be included in an additional portion of the user interface (e.g., see user interface element 1008). In example embodiments, the user interface may include a field for specifying a new value if an appropriate value for the attribute for the item is not found.

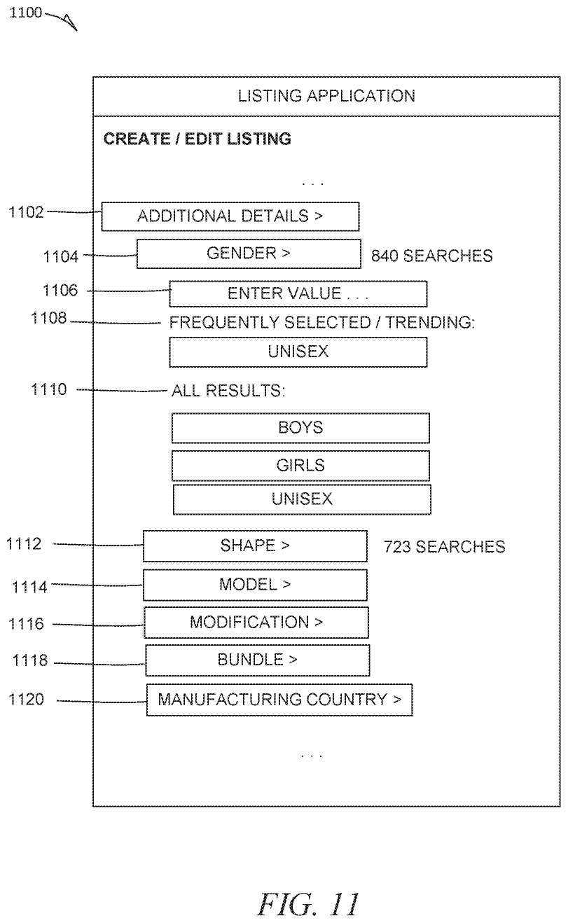

FIG. 11 is a diagram depicting an example user interface 1100 that includes enhancements for specifying values of additional attributes of an item. In example embodiments, the user interface 1100 may be generated and communicated to a client device for presentation on the client device by one or more modules of the enhanced listing management application(s) 234.

As depicted, the additional details (outside a configurable top number of attributers) are expanded in a portion of a user interface for managing a listing. User interface elements corresponding to known or previously-specified additional attributes for the item (or similar items or a matching category of items) are provided that are further expandable for specifying appropriate values (see, e.g., user interface elements 1104, 1106, 1112, 1114, 1116, 1118, and 1120). Currently, as depicted, one of the additional details has been further expanded (see, e.g., user interface element 1104). In example embodiments, a portion of the expanded user interface under each additional element is reserved for frequently selected or trending values (e.g., see user interface element 1108) that may be specified instead of, or in addition to, the selected element. Although not depicted in FIG. 11, in addition to an indication of the trending direction (e.g., an up or down arrow), each value may be supplemented with data pertaining to an amount of boost the listing will get if the value is specified for the listing (e.g., see user interface elements 1010 and 1012 of FIG. 10). In example embodiments, the user interface may include a field for specifying a new value if an appropriate value for the attribute for the item is not found.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 104 of FIG. 1) and via one or more appropriate interfaces (e.g., APIs).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

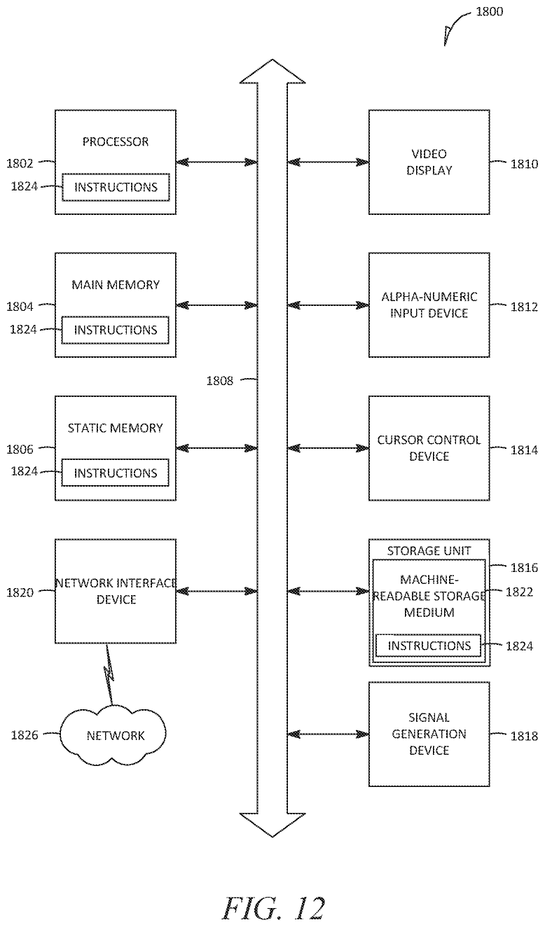

FIG. 12 is a block diagram of machine in the example form of a computer system 1800 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1800 includes a processor 1802 (e.g., a central processing unit (CPU), a graphics processing unit (GPU) or both), a main memory 1804 and a static memory 1806, which communicate with each other via a bus 1808. The computer system 1800 may further include a video display unit 1810 (e.g., a liquid crystal display (LCD) or a cathode ray tube (CRT)). The computer system 1800 also includes an alphanumeric input device 1812 (e.g., a keyboard), a user interface (UI) navigation (or cursor control) device 1814 (e.g., a mouse), a storage unit 1816, a signal generation device 1818 (e.g., a speaker) and a network interface device 1820.

The storage unit 1816 includes a machine-readable storage medium 1822 on which is stored one or more sets of data structures and instructions 1824 (e.g., software) embodying or utilized by any one or more of the methodologies or functions described herein. The instructions 1824 may also reside, completely or at least partially, within the main memory 1804 and/or within the processor 1802 during execution thereof by the computer system 1800, the main memory 1804 and the processor 1802 also constituting machine-readable media. The instructions 1824 may also reside, completely or at least partially, within the static memory 1806.

While the machine-readable storage medium 1822 is shown in an example embodiment to be a single medium, the term “machine-readable storage medium” may include a single medium or multiple media (e.g., a centralized or distributed database, and/or associated caches and servers) that store the one or more instructions 1824 or data structures. The term “machine-readable storage medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable storage medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and compact disc-read-only memory (CD-ROM) and digital versatile disc (or digital video disc) read-only memory (DVD-ROM) disks.

Accordingly, a “tangible machine-readable storage medium” may refer to a single storage apparatus or device, as well as “cloud-based” storage systems or storage networks that include multiple storage apparatus or devices. Furthermore, the tangible machine-readable storage medium is non-transitory in that it does not embody a propagating signal. However, labeling the tangible machine-readable storage medium as “non-transitory” should not be construed to mean that the medium is incapable of movement—the medium should be considered as being transportable from one physical location to another. Additionally, since the machine-readable medium is tangible, the medium may be considered to be a machine-readable device.

The instructions 1824 may further be transmitted or received over a communications network 1826 using a transmission medium. The instructions 1824 may be transmitted using the network interface device 1820 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding or carrying instructions for execution by the machine, and includes digital or analog communications signals or other intangible media to facilitate communication of such software. The network 1826 may be one of the networks 104.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
causing presentation, on a client device, of an improved user interface for managing listings of items on a network-based publication system, the causing including:
identifying that an importance of specifying a value of an attribute for an item has transgressed an importance threshold with respect to a probability of a transaction being completed with respect to a listing of the item;
identifying that the value for the attribute has not been specified with respect to the listing of the item; and
communicating, in the user interface, the importance of specifying the value in conjunction with providing, in the user interface, an interactive user interface element for specifying the value with respect to the listing.

2. The method of claim 1, wherein the causing of the presentation, on the client device, of the improved user interface occurs during a listing flow for the item, the listing flow being a series of steps in which a seller initiates a publishing of the listing of the item on the network-based publication system.

3. The method of claim 1, wherein the identifying that the importance has transgressed the importance threshold and the causing of the presentation, on the client device, of the improved user interface occurs after the listings has been posted.

4. The method of claim 3, wherein the identifying that the importance has transgressed the importance threshold is based on an identification of a trend in a plurality of transactions pertaining to a type of the item over a configurable time period.

5. The method of claim 1, wherein the communicating of the importance of specifying the value includes presenting a ranking of attributes pertaining to the item with respect to the probability of the transaction being completed with respect to the listing of the item.

6. The method of claim 1, wherein the causing publication further comprises inferring a set of possible values for the attribute based on other values specified for other attributes in the listing of the item, and wherein the interactive user interface element facilitates selection of one of the possible values as the value for the attribute of the item.

7. The method of claim 6, wherein at least one of the other values is an image specified for an image attribute of the item and the inferring is based on identification of features included in the image.

8. A system comprising:
one or more computer processors;
one or more computer memories;
a set of instructions incorporated into the one or more computer memories, the set of instructions configuring the one or more computer processors to perform operations comprising:
causing presentation, on a client device, of an improved user interface for managing listings of items on a network-based publication system, the causing including:
identifying that an importance of specifying a value of an attribute for an item has transgressed an importance threshold with respect to a probability of a transaction being completed with respect to a listing of the item;
identifying that the value for the attribute has not been specified with respect to the listing of the item; and
communicating, in the user interface, the importance of the specifying of the value in conjunction with providing in the user interface an interactive user interface element for specifying the value with respect to the listing.

9. The system of claim 8, wherein the causing of the presentation, on the client device, of the improved user interface occurs during a listing flow for the item, the listing flow being a series of steps in which a seller initiates a publishing of the listing of the item on the network-based publication system.

10. The system of claim 8, wherein the identifying that the importance has transgressed the importance threshold and the causing of the presentation on the client device of the improved user interface occurs after the listings has been posted.

11. The system of claim 10, wherein the identifying that the importance has transgressed the importance threshold is based on an identification of a trend in a plurality of transactions pertaining to a type of the item over a configurable time period.

12. The system of claim 8, wherein the communicating of the importance of specifying the value includes presenting a ranking of attributes pertaining to the item with respect to the probability of the transaction being completed with respect to the listing of the item.

13. The system of claim 8, wherein the operations further comprise inferring a set of possible values for the attribute based on other values specified for other attributes in the listing of the item and wherein the interactive user interface element facilitates selection of one of the possible values as the value for the attribute of the item.

14. The system of claim 13, wherein at least one of the other values is an image specified for an image attribute of the item and the inferring is based on identification of features included in the image.

15. A non-transitory computer-readable storage medium storing a set of instruction that, when executed by one or more computer processors, cause the one or more computer processors to perform operations comprising:
causing presentation, on a client device, of an improved user interface for managing listings of items on a network-based publication system, the causing including:
identifying that an importance of specifying a value of an attribute for an item has transgressed an importance threshold with respect to a probability of a transaction being completed with respect to a listing of the item;
identifying that the value for the attribute has not been specified with respect to the listing of the item; and
communicating, in the user interface, the importance of the specifying of the value in conjunction with providing in the user interface an interactive user interface element for specifying the value with respect to the listing.

16. The non-transitory computer-readable storage medium of claim 15, wherein the causing of the presentation, on the client device, of the improved user interface occurs during a listing flow for the item, the listing flow being a series of steps in which a seller initiates a publishing of the listing of the item on the network-based publication system.

17. The non-transitory computer-readable storage medium of claim 15, wherein the identifying that the importance has transgressed the importance threshold and the causing of the presentation on the client device of the improved user interface occurs after the listings has been posted.

18. The non-transitory computer-readable storage medium of claim 17, wherein the identifying that the importance has transgressed the importance threshold is based on an identification of a trend in a plurality of transactions pertaining to a type of the item over a configurable time period.

19. The non-transitory computer-readable storage medium of claim 15, wherein the communicating of the importance of specifying the value includes presenting a ranking of attributes pertaining to the item with respect to the probability of the transaction being completed with respect to the listing of the item.

20. The non-transitory computer-readable storage medium of claim 15, wherein the operations further comprise inferring a set of possible values for the attribute based on other values specified for other attributes in the listing of the item and wherein the interactive user interface element facilitates selection of one of the possible values as the value for the attribute of the item.
